(19) United States
(12) Patent Application Publication
(10) Pub. No.: US 2009/0125602 A1
(43) Pub. Date: May 14, 2009

(54) AUTOMATIC PRIORITY ADJUSTMENT FOR INCOMING EMAILS

(75) Inventors: UPINDER K. BHATIA, Brookfield, CT (US); Jenny S. Li, Danbury, CT (US); Amarjit Bahl, Brookfield, CT (US)

Correspondence Address: FLEIT, GIBBONS, GUTMAN,;BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 11/940,145

(22) Filed: Nov. 14, 2007

(51) Int. Cl. G06F 15/16

(52) U.S. Cl. 709/207

(57) ABSTRACT

A method, an information processing system, and a computer readable storage medium for at least one of assigning and dynamically adjusting a priority level associated with an email message. The method includes receiving at least one email message associated with a recipient. Definitions of a plurality of priority assignment parameters and respective priority levels that are associated with each of the plurality of priority assignment parameter are accepted from a user. At least one identified priority assignment parameter within the plurality of priority assignment parameters is identified within the at least one email message. A corresponding priority level that is associated with the at least one identified priority assignment parameter is assigned to the at least one email message.

### FIELD OF THE INVENTION

The present invention generally relates to the field of e-mail messaging, and more particularly relates to automatically assigning and adjusting priority levels associated with email messages based on various priority assignment parameters.

### BACKGROUND OF THE INVENTION

Email messaging has become an integral part of businesses worldwide. An average employee can send and receive large numbers emails every day. As employees interact with more people, the number of email messages sent/received by that employee can grow very rapidly. Prioritizing email messages can become a very tedious and time consuming task, especially when a large number of email messages exist in an inbox. Without proper prioritization a user may overlook critical email messages or delay in responding to important messages.

Various systems exist for prioritizing email messages. A common prioritization method is to have a sender designate a priority level for a message. However, the recipient may not agree with the priority level assigned to the message. Another prioritization method allows the recipient to manually parse through each received email message and assign a priority level to each email message. This method is problematic because if a user has numerous emails, parsing through each email can become very time consuming.

Furthermore, if a user assigns an incorrect priority level to a message, critical messages may not be acted upon in a timely manner such as in customer support environments. Other prioritization systems allow users to define rules that are applied to email messages that have been received. For example, a user can define a rule that flags messages received from an individual or groups of individuals. These rules can also identify messages containing specific words and set priority levels accordingly. The flag can indicate that the messages need immediate attention. However, the priority levels assigned to messages in this system and the other systems described above are static and are therefore limited in their ability to adapt to changing conditions.

### SUMMARY OF THE INVENTION

Briefly, in accordance with the present invention, disclosed are a method, information processing system, and computer readable storage medium for at least one of assigning and dynamically adjusting a priority level associated with an email message. The method includes receiving at least one email message associated with a recipient. Definitions of a plurality of priority assignment parameters and respective priority levels that are associated with each of the plurality of priority assignment parameter are accepted from a user. At least one identified priority assignment parameter within the plurality of priority assignment parameters is identified within the at least one email message. A corresponding priority level that is associated with the at least one identified priority assignment parameter is assigned to the at least one email message.

In another embodiment an information processing system for at least one of assigning and dynamically adjusting a priority level associated with an email message is disclosed. The information processing system includes a processor and a memory that is communicatively coupled to the processor. An email client is adapted to receive at least one email message associated with a recipient. A priority manager is adapted to accept definitions of a plurality of priority assignment parameters and respective priority levels that are associated with each of the plurality of priority assignment parameter and identify at least one priority assignment parameter within the at least one email message. A priority assigner is adapted to assign a corresponding priority level that is associated with the at least one identified priority assignment parameter.

In yet another embodiment, a computer readable storage medium for at least one of assigning and dynamically adjusting a priority level associated with an email message is disclosed. The computer readable storage medium comprises instructions for receiving at least one email message associated with a recipient. Definitions of a plurality of priority assignment parameters and respective priority levels that are associated with each of the plurality of priority assignment parameter are accepted from a user. At least one identified priority assignment parameter within the plurality of priority assignment parameters is identified within the at least one email message. A corresponding priority level that is associated with the at least one identified priority assignment parameter is assigned to the at least one email message.

One advantage of the present invention is that priority levels associated with received email messages can be automatically assigned and dynamically adjusted. The priority levels can be assigned based on various priority assignment parameters that can be dynamic. Also, the assigned priority levels can be dynamically updated when a conflict is identified and/or based on related email events.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram of an exemplary system for assigning and adjusting priority levels for email messages according to an embodiment of the present invention;

FIG. 2 is a table illustrating an exemplary priority table according to an embodiment of the present invention;

FIG. 3 is a detailed view of an information processing system according to an embodiment of the present invention;

FIG. 4 is an operational flow diagram illustrating an exemplary process of automatically assigning and dynamically adjusting a priority level for an email message according to an embodiment of the present invention;

FIG. 5 illustrates a Priority Level profile according to an embodiment of the present invention;

FIG. 6 illustrates another example of a Priority Level profile according to an embodiment of the present invention;

FIG. 7 is an operational diagram illustrating another exemplary process of assigning and adjusting priority levels associated with email messages according to an embodiment of the present invention; and

FIG. 8 illustrates one example of an organizational directory, in accordance with an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Email Priority Assignment and Updating System

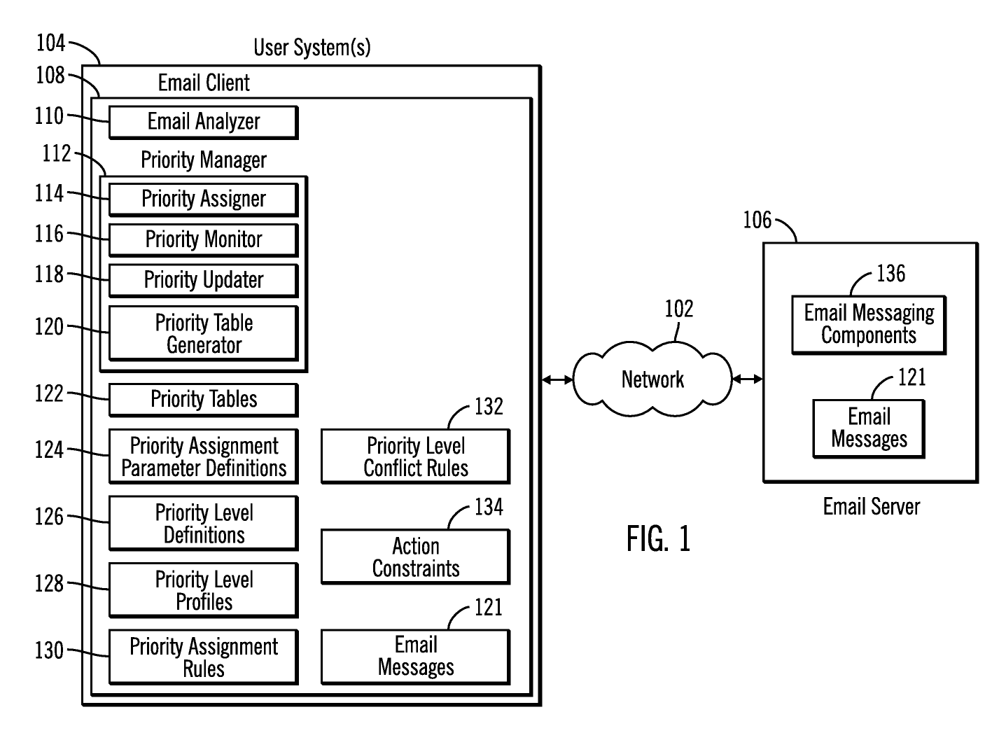

FIG. 1 is a block diagram illustrating an exemplary priority assignment system 100 for assigning and dynamically adjusting priority levels associated with email messages according to an embodiment of the present invention. The priority assignment system 100 of the present invention automatically assigns a priority level to email messages based on various priority assignment parameters defined by the user and/or enterprise policies. The priority assignment system 100 also dynamically updates a priority level associated with an email message based on priority assignment parameters associated with related email messages.

In one embodiment, the priority assignment system 100 includes a network 102, which is able to be a wired and/or wireless network. Communicatively coupled to the network 102 are one or more user systems 104 and one or more email servers 106. A user system 104 can comprise of a desktop computer, a laptop, a personal digital assistant, a cellular telephone, a mobile phone, a smartphone, a wireless messaging device, and the like.

The user system 104 includes an email client 108, which can be a stand-alone application and/or a web interface client. For example, the email client 108 can be an application that provides local email messaging functionality to a user and communicates with the email server 106. Alternatively, the email client 108 can be a web interface client that allows a user to connect to the email server 106 via a public network such as the Internet and provides remote email messaging functionality to the user.

The email client 108, in one embodiment, includes an email analyzer 110 that analyzes each received email 121 to identify matching priority assignment parameters 124 contained in those messages that are to be used in determining a priority level for each message. Priority assignment parameters 124 can be defined by the user and/or a system administrator or be derived automatically. Priority assignment parameters 124 are utilized by a priority manager 112 to assign priority levels and dynamically update priority levels associated with received email messages 121. Priority assignment parameters 124 are able to be, for example, a sender's email address; an email group that the sender belongs to; an internal work group that the sender belongs to; specific keywords in an email message; the location of the recipient's email address within the message such as the “To” field, “CC” field, and the like; a context associated with the email such as a work project to which an email is related; a relationship of a sender with respect to a context of an email, such as co-worker A sending a message with respect to project A as compared to a co-worker B sending a message with respect to project B; a number of recipient's addressed by an email message; the location of a recipient's email address within a group of recipients; hierarchical status of the sender within an organization such as level 1 manager or level 2 manager; the time elapsed since the email had been received if no response has been sent; the confidential nature of the email; and the like. It should be noted that these priority assignment parameters 124 are only examples and do not limit the present invention in any way.

The priority manager 112, in one embodiment, includes a priority level assigner 114 that assigns a priority level to an email message 121. The priority manager 112 also includes a priority level monitor 116 that monitors the priority levels of each email message 121 and determines if a priority conflict exists or whether a priority level of an email 121 should be updated based on priority assignment parameters. A priority level updater 118 updates the priority level assigned to an email message 121 in response to a priority conflict existing or a priority level adjustment determination being made by the priority level monitor 116. The priority manager 112 also includes a priority table generator 120 that generates priority tables 122 for tracking the priority level of an email message 121 and its related messages. The priority manager 112, its respective components, and the priority level assignment/updating processes are discussed in greater detail below.

The email client 108 also includes email messages 121 that have been received from the email server 106. It should be noted that the email messages 121 can be entire email messages and/or partial email messages such as headers. The email client 108 further comprises priority assignment parameters 124 (as discussed above), priority level definitions 126, Priority Level profiles 128, priority assignment rules 130, priority level conflict rules 132, and action constraints 134. Further embodiments of the present invention are able to omit one or more of these components. These components are discussed below. Also, each of these components 124, 126, 128, 130, 132, 134 is discussed in greater detail below.

It should also be noted that one or more of the identified components in the email client 108 is able to reside outside of the email client 108. Furthermore, one or more of these components are also able to reside within the email server 106. The email server 106, in one embodiment, includes email messaging components 136, the functions of which are understood by those of ordinary skill in the art in light of the present description. The email server 106 also includes email messages 121 that are received by the user system 104. It should be noted that the present invention can also be entirely implemented at or partially implemented at the email server 106.

Priority Level Assignment And Adjustment for Email Messages

As discussed above, the embodiments of the present invention automatically assign (e.g., without user intervention) and dynamically adjust priority levels associated with email messages received by a user in light of changing conditions that define the priority assignments to be made. Therefore, a user 104 can better utilize his/her time and address more important tasks rather than searching for important email messages. A user 104, via the email client 108 or another interface, creates priority level definitions 126 that define a priority level or type for received email messages. A priority level or priory type, in one embodiment, is a category in a range of categories. For example, a priority type can be “low”, “medium,” “high”, “low-medium”, “medium-high”, “1”, “2”, “3 . . . n”, “hot”, “not hot” and the like. These priority levels or types indicate a level of importance to the user 104 where, for example, a higher importance email requires more urgent attention than a lower importance email.

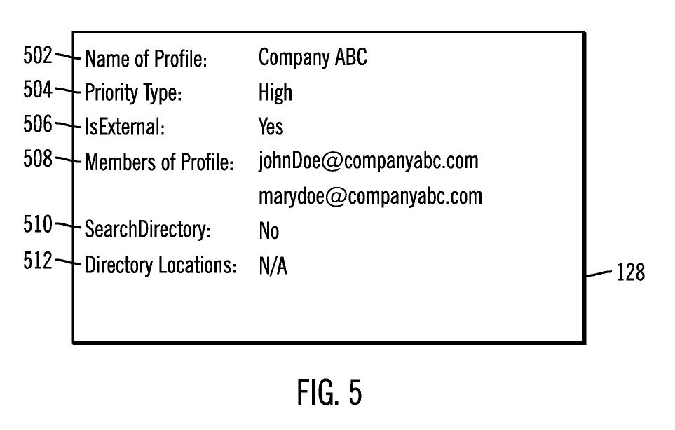

For each priority type, the user 104 can also create Priority Level profiles 128. Priority Level profiles 128 allow for a priority to be associated to one or more emails 121 based on, for example, a hierarchical or nested grouping of people. For example, FIG. 5 shows one example of a Priority Level profile 128. The Priority Level profile 128 of FIG. 5 includes a profile name field 502, a priority type field 504, an external user field 506, a profile member field 508, a search directory field 510, and directory location field 512.

The profile name field 502 includes the name of the profile such as “Company ABC”. In the example of FIG. 5, John Doe and Mary Doe from Company ABC are of high priority as indicated by the priority field 504. The email address of John Doe and Mary Doe are listed in the profile member field 508. Therefore, any email messages 121 received from these two individuals, in one embodiment, are automatically associated with a priority level of “High”. The flag “IsExternal” 506 indicates that this profile 128 applies to people who do not belong to the same company as the recipient user 104. The search directory field 508 indicates whether a user directory is required to be search to, for example, determine other email addresses for that individual. However, in this example, the users johnDoe@companyabc.com and marydoe@companyabc.com have already been specified. Therefore, a directory associated with Company ABC does not need to be searched. If a directory needed to be search its location is indicated by the directory location field 512. In one embodiment of the present invention, the directory is externally stored data in that it is data that is stored externally to the mail processing system.

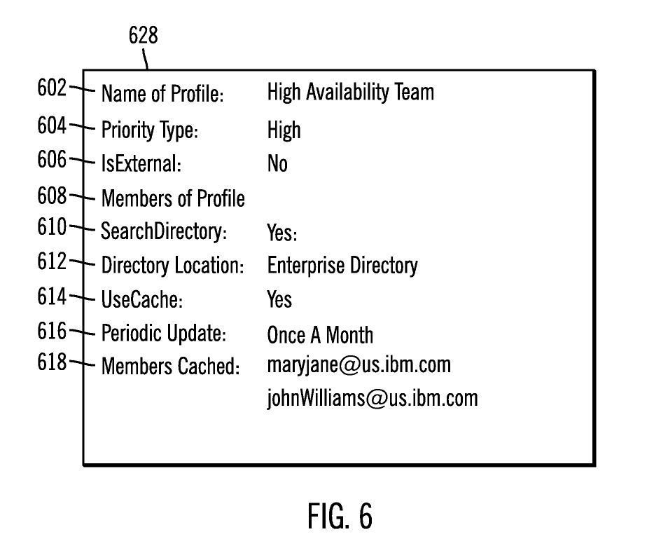

FIG. 6 illustrates another example of a Priority Level profile. FIG. 6 shows a Priority Level Profile 628 comprising a profile name field 602, a priority type field 604, an external user field 606, a profile member field 608, a search directory field 610, directory location field 612, a cache field 614, a periodic update field 616, and a member cached field 618. In this example, the profile name field 602 includes the profile name of “High Availability Team”. This priority profile 128 indicates that email messages 121 from members of the High Availability Team are to be assigned a “High” priority level, as indicated by the priority level field 604. The team is internal since as indicated by the external user field 606 being set to “No”.

Specific members of the High Availability Team have not been listed in this profile, but a location of the member directory has been given in the directory location field 612. Therefore, the priority manager 112 searches the “Enterprise Directory” to determine members of the High Availability team, thereby allowing the priority profile to be effectively updated dynamically as the High Availability team definition changes in the enterprise directory. The cache field 614 indicates to the priority manager 112 whether identified members of the High Availability Team that are determined by accessing the Enterprise Directory are to be stored in a cached for future use as email messages are received and also whether the member cache is to be queried instead of directly searching the “Enterprise Directory” for each received and processed email. For example, when the priority manager 112 searches the Enterprise Directory to identify members of the High Availability Team, it caches the email addresses of the identified members as shown in FIG. 6 in the members cached field 618 (e.g., maryJane@us.ibm.com and johnWilliams@us.ibm.com).

Alternatively, the priority manager 112 can query the cached members to identify previously identified High Availability Team members as new e-mails are received. The periodic update field 616 indicates to the priority manager 112 how often to update the cached members from the Enterprise Directory. In the example of FIG. 6, the cached members are updated once every month. As can be seen from the examples shown in FIG. 5 and FIG. 6, the priority profiles 128 allow for the priority manager 112 to automatically assign a priority level to members of a group. It should be noted that the priority profiles 128 shown in FIG. 5 and FIG. 6 are only examples and do not limit the present invention.

A user client 104 can also define priority assignment rules 130 that govern how a priority level is assigned to email messages 121. In one embodiment, the priority assignment rules 130 are based on tiers, which are able to include a single tier or be multi-tiered. The priority assignment rules 130 indicate to the priority manager 112 how to assign a priority level to an email message 121 based on priority assignment parameters 124. For example, a first tier rule can identify various priority assignment parameters 124 such as sender of an email; topic; addressee list criteria; and the like. This exemplary first tier rule can indicate to the priority manager 112 that if the sender of an email is specified in a priority profile 128, then assign a priority level to that email based on the priority profile 128. For example, if the sender is marydoe@companyabc.com, the priority assigner 114 of the priority manager 112 assigns a priority level to the email 121 based on the priority profile 128 of shown in FIG. 5. In this example, if the sender is not associated with a priority profile 128, a default priority level (as defined by the recipient user 104 or system administrator) can be assigned to the email 121. Multiple tiers of priority assignment rules in one embodiment of the present invention define a priority assignment rule application sequence for applying multiple priority assignment rules to email messages.

The exemplary first tier rule can also indicate to the priority manager 112 that if the topic or subject of the email comprises specified words, a priority level based on the identified specified word(s) should be assigned to that email. For example, the word “Urgent” can be a defined priority assignment parameter within the priority assignment parameter definitions list 124 that is to be associated with the priority level of “High”. Therefore, if an email message 121 has a subject including the word “Urgent”, the priority assigner 114 of the priority manager 112 assigns a priority level of “High” to the email message 121. The exemplary first tier rule can also indicate a priority adjustment based on the addressee list of the message.

For example, a recipient user client 104 or system administrator can configure the priority manager 112 to assign different priorities to an email message 121 based on the location of the recipient's address within an address list or based on which address field the recipient's address is in. In one embodiment, if the recipient's address is the only address associated with the email message 121, priority assignment rules 130 can indicate to the priority manager 112 that this email message 121 is of high importance. If other recipients are associated with the email message 121, the priority assignment rules 130, in one embodiment, indicate that a medium priority level can be assigned to the email. Alternatively, if the recipient's address is within the “CC” field of the message, a lower priority level can be assigned to the email message 121 than if the recipient's address is in the “To” field.

Another example is a second tier rule that indicates to the priority manager 112 that priority assignment parameters 130 based on contexts are to be used when assigning priority levels. In this embodiment, the priority manager 112 analyzes the email message 121 to determine contextual relationships between the sender and recipient and/or between the content of the email message, the sender, and the recipient. For example, if a manager at a level above the recipient user sends an email message 121, the priority manager 112 (based on this exemplary second tier rule) assigns a priority level of “High”. In one embodiment, an organization directory can be queried by the priority manager 112 to determine the hierarchical relationship (e.g., worker-manager; worker-co-worker; and the like) between the sender and the recipient user 104. In another example based on the exemplary second tier rule, the priority manager 112 can determine that the sender is co-worker A of the recipient for project A and assigns a higher/lower priority level than the level assigned to an email from co-worker B for project B.

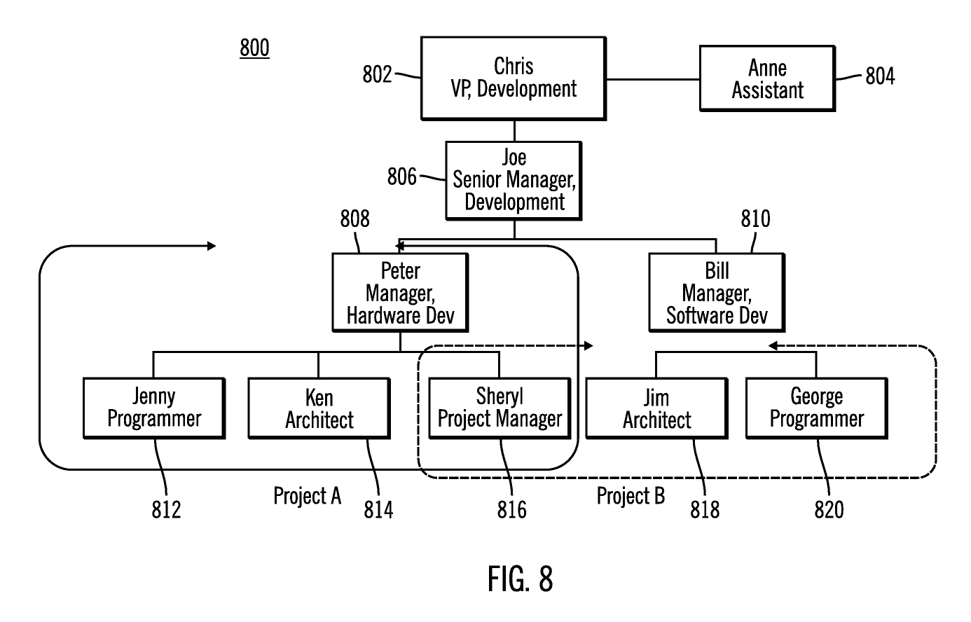

FIG. 8 shows one example of an organizational directory 800. In particular, the organizational directory 800 shows a hierarchical organizational structure of project/team members. For example, Chris 802 is Vice President of Development and has an assistant Anne 804. Joe 806 is the Senior Manager of Development and manages Peter 808 who is the Manager of Hardware Development and Bill 810 who is the Manager of Software Development. Peter 808 manages Jenny 812 who is a Programmer, Ken 814 who is an Architect, and Sheryl 816 who is a Project Manager. Bill 810 manages Jim 818 who is an Architect and George 820 who is a Programmer.

In this example, assume George 820 receives an email from Peter 808 (the manager from a sister team) and that the email subject mentions “Project A”. The priority manager 112 can initially designate the email as high priority since Peter 808 is a manager and he is more senior than George 820. However, since Peter's email has the subject being “Project A” and George 820 is not part of the Project A team, the Priority Manager 112 lowers the priority to be medium as a result.

In another example, George 820 receives an email from Sheryl 816 (a Project Manager in a sister team) and the email has the subject of “Project B”. The priority manager 112 initially assigns a low priority to the email because Sheryl 816 is not a manager and also determines that Sheryl 816 is not more senior than George 820. However, since the subject of the email mentions “Project B”, the email is likely important to George 820 as George 820 and Sheryl 816 are both working in Project B. Therefore, the priority manager 112 adjusts the priority to medium.

In yet another example, assume that George 820 receives an email from Anne 804 (the assistant of the VP of his organization). The priority manager 112 can initially assign a low priority to the email because Anne 804 is not one of George's managers. However, since Anne 804 is an assistant of Chris 802 who is the VP of George's organization, the priority manager 112 adjusts the priority to medium. If George is the only recipient of the email the priority manager 112 can adjust the priority to high.

In another embodiment, a priority assignment rule 130 can also instruct the priority manager 112 how to assign priority levels based on priority assignment parameters 124 associated with the complexity of an email message 121. A third tier rule 130 can instruct the priority manager 112 to analyze priority assignment parameters 124 such as, for example, the number of people that have responded to the email; additional recipients that were added to multiple responses over time; and the like. In this example, the priority manager 112 can determine that a certain number of people have responded to the email message and assign a higher priority to that message. Alternatively, the priority manager 112 can determine that because more people are responding to the email, less attention is required by the recipient user. Therefore, a lower priority level can be assigned to the email message 121. As can be seen, the priority assignment rules 130 can be combined to create multi-tiered rules 130. A user 104 can configure the priority manager 112 to apply all tiers or only specifically designated tiers of priority assignment rules 130.

As discussed above, the priority manager 112 also includes a priority table generator 120 that generates one or more priority tables 122 associated with a user. These priority tables 122 allow the priority manager 112 to monitor the priority levels associated with each received email 121 and related events such as responding/forwarding of a received email 121 by this user or other users.

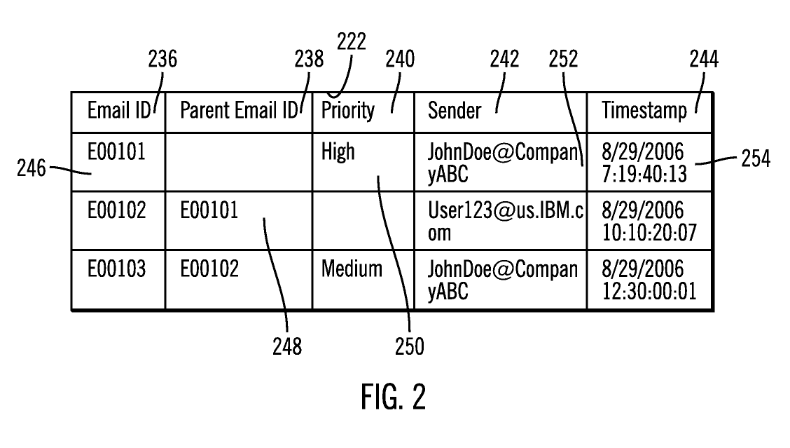

FIG. 2 shows one example of a priority table 222. The priority table 222 is used to store the relationships of related messages such as a string of responses to an origination email. The priority table 222 of FIG. 2 includes an “Email ID” field 236, a “Parent Email ID” field 238, a “Priority” field 240, a “Sender” field 242, and a “Timestamp” field 244. It should be noted that these fields are only exemplary and do not limit the present invention in any way. The Email ID field 236 includes entries 246 that include a unique identifier for each received email message 121. The Parent Email ID field 238 includes entries 248 that include the Email ID of the parent email associated with the particular received email message 121. The Priority field 240 comprises entries 250 that include the priority level indicators assigned to the particular email message 121. The Sender field 242 comprises entries 252 that identify the sender of the particular email message 121. The Timestamp field 244 comprises entries 254 that indicate the time/date of when the email 121 was sent and/or received.

In the example of FIG. 2, a first email with an Email ID of E00101 was received by the user from johnDoes@companyABC. The priority manager 112, based on a priority assignment rule 130, has assigned a priority of “High” to the email E00101. For example, the priority assignment rule 130 instructed the priority manager 112 to apply any applicable priority profile 128, which resulted in the priority being assigned as “High”. In this example, if any additional tiers were included within the rule they are also applied (which can result in priority conflicts as discussed in greater detail below). The recipient of email ID E00101 then responds to that email. This response email is given the Email ID of E00102 and has a Parent Email ID of E00101.

The original recipient of email ID E00101, who also sent the email with email ID E00102, receives a response email E00103 to the email E00102 from jonhDoe@company and the priority manager 112 has assigned a priority of “Medium” to the newly received email E00103. In this example, the sender jonhDoe@company also included other recipients in the “To” field of the response email E00103. The particular rule being used by the priority manager 112, in this example, indicates that in this situation (where the recipient user is not the only addressed recipient) a priority “Medium” is to be assigned to the received email.

As can be seen from FIG. 2 conflicting priorities can exist between related email messages. In one embodiment, the priority monitor 116 of the priority manager 112 identifies these conflicts between related email messages 121 and determines how to resolve conflicts. For example, the priority monitor 116 analyzes conflict rules 132 defined by the user 104 and/or system administrator to determine whether there are conflicts to be resolved. If the priority monitor 116 determines that there are conflict(s) to be resolved, the priority level updater 118 updates the priority level of an email message 121 based on one or more of the conflict rules 132. For example, a conflict rule 132 can indicate that if a conflict exists between two related emails, the highest priority between the emails is to be assigned. Using the example of FIG. 2, the “Medium” priority is updated to “High”. A conflict rule 132 can also indicate that if a conflict exists between two related emails the last assigned priority between the emails is to be used. For example, in FIG. 2, the “Medium” priority was the last priority level assigned. Therefore, the “High” priority is changed to “Medium”. Alternatively, a conflict rule 132 can indicate that an average of all priorities it to be used. For example, in FIG. 2, a priority level of “Medium-High” is assigned to each of the related emails E00101 and E00103,

It should be noted that priorities of related emails are not limited to being updated only when a conflict occurs. For example, the priority monitor 116 can also monitor email based events associated with related emails. For example, a first email is received by the user where the user is the only recipient in the “To” field of the message. Therefore, the priority manager 112 assigns a priority level of “High to the email message. The user responds to that message and subsequently receives a response back from the sender. However, the priority monitor 116 determines that the received response was also addressed to numerous other recipients as well. Therefore, the priority updater 118, in one example, has a rule to downgrade the priority of the original email to “Medium”. In another example, a user receives an email message from a sender and the priority manager 112 assigns a priority level of “Medium” to the message. The priority monitor 116 determines that multiple people sent responses to the original email message that was also received by the user. Therefore, in one example, the priority updater 118 has a rule to upgrade the priority level form “Medium” to “High”.

In one embodiment, the priority adjustment feature of the present invention is user selectable. A user can configure the priority manager to perform priority adjustment only when certain criteria are met. For example, the priority manager 112 can be configured to perform priority adjustment when a number of emails in an inbox are above a threshold. The priority manager 112 can also be configured to perform priority adjustment when the number of unread emails is above a threshold. The priority manager 112 can also be configured to perform priority adjustment when a number of emails are received during a predefined window of time such as when the user is away on vacation. It should be noted that one or more of these configurations, along with other possible configurations, are possible.

In addition to configuring priority adjustment, a user can also configure the priority manager 112 with active constraints 134. Active constraints are used to create time constraints on the actions of a user once a priority level is assigned to an email message 121. The priority manager 112 can set a time limit in which the user is required to respond to a message. For example, the priority manager 112 can tag each email with a priority level of “High” with a constraint that the user 104 needs to respond to the message one hour prior to closing. The priority table 122 can be appended to include these constraints. The priority manager 122 can also send an alert to the user 104 via email, text messaging, voice call, instant message, or the like to notify the user 104 that an email needs to be responded to or that a response is overdue.

As can be seen from the above discussion, the present invention provides a system for assigning a dynamically adjusted priority level to received email messages. The priority levels can be assigned based on various priority assignment parameters. Also, the assigned priority levels can be dynamically updated when a conflict is identified and/or based on related email events. It should be noted that rendering the priority assignment rules associated with these parameters can have different results. As an example, a user defines the following priority assignment rules: Rule 1—all emails from the Project A team are to be marked as “High” priority; and Rule 2—priority of all emails that have been received for more than one month without any related email events (e.g., the user or other recipients do not respond back) are to be adjusted. In this example with these defined rules, the user receives an email on August 1 from Jenny. Jenny is part of the Project A team, so the email is marked “High” for priority. One month passes and the user has not responded to this email. However, on August 20, Jenny left the Project A team and is assigned to a different position. So according to the combination of the two rules, the email was marked high when received on August 1, but on September 1, according to Rule 2, the priority should be adjusted since the user has not responded to the email within the defined one month window. When the priority manager 112 evaluates Rule 1 again on September 1, it discovers that Jenny is no longer part of Project A from the information in the company's user directory. Therefore, due to the priority definitions in this example, the email is be marked with a lower priority.

Information Processing System

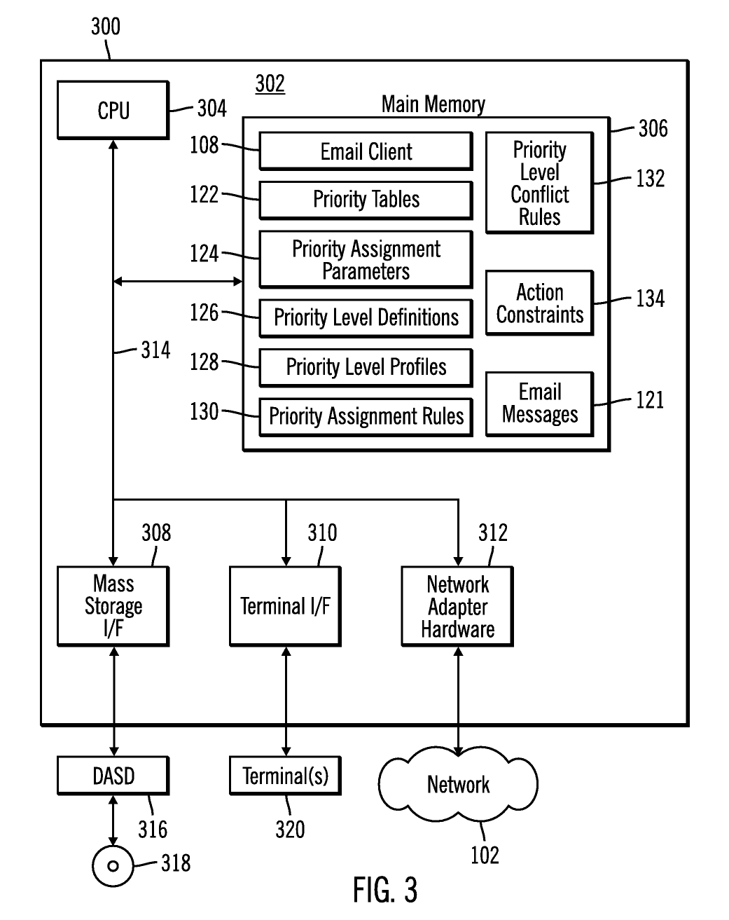

FIG. 3 is a block diagram illustrating a more detailed view of an information processing system 300 such as the user system 104 or the email sever 106 according to an embodiment of the present invention. The information processing system 300 is based upon a suitably configured processing system adapted to implement the exemplary embodiment of the present invention. Any suitably configured processing system is similarly able to be used as the information processing system 300 by embodiments of the present invention such a personal computer, workstation, or the like.

The information processing system 300 includes a computer 302. The computer 302 has a processor 304 that is connected to a main memory 306, mass storage interface 308, terminal interface 310, and network adapter hardware 312. A system bus 314 interconnects these system components. The mass storage interface 308 is used to connect mass storage devices, such as data storage device 316, to the information processing system 300 system. One specific type of data storage device is a computer readable medium such as a floppy disk drive, which may be used to store data to and read data from a CD 318 or a floppy diskette (not shown). Another type of data storage device is a data storage device configured to support, for example, NTFS type file system operations.

The main memory 306, in one embodiment, comprises the email client 108 program and its respective components, which have been discussed above in greater detail. The main memory 308 also includes data structures storing the priority tables 122, priority assignment parameters 124, priority level definitions 126, Priority Level profiles 128, priority assignment rules 130, priority level conflict rules 132, action constraints 134, and email messages 121, all of which have been discussed in greater detail above.

Although illustrated as concurrently resident in the main memory 306, it is clear that respective components of the main memory 306 are not required to be completely resident in the main memory 306 at all times or even at the same time. In one embodiment, the information processing system 300 utilizes conventional virtual addressing mechanisms to allow programs to behave as if they have access to a large, single storage entity, referred to herein as a computer system memory, instead of access to multiple, smaller storage entities such as the main memory 306 and data storage device 316. Note that the term “computer system memory” is used herein to generically refer to the entire virtual memory of the information processing system 300.

Although only one CPU 304 is illustrated for computer 302, computer systems with multiple CPUs can be used equally effectively. Embodiments of the present invention further incorporate interfaces that each includes separate, fully programmed microprocessors that are used to off-load processing from the CPU 304. Terminal interface 310 is used to directly connect one or more terminals 320 to computer 302 to provide a user interface to the computer 302. These terminals 320, which are able to be non-intelligent or fully programmable workstations, are used to allow system administrators and users to communicate with the information processing system 102. The terminal 320 is also able to consist of user interface and peripheral devices that are connected to computer 302 and controlled by terminal interface hardware included in the terminal I/F 310 that includes video adapters and interfaces for keyboards, pointing devices, and the like.

An operating system (not shown) included in the main memory is a suitable multitasking operating system such as the Linux, UNIX, Windows XP, and a Windows Server operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 300. The network adapter hardware 312 is used to provide an interface to a network 102. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via CD or DVD, e.g. CD 318, CD ROM, or other form of recordable media, or via any type of electronic transmission mechanism.

Process of Assigning and Adjusting Priority Levels For Email Messages

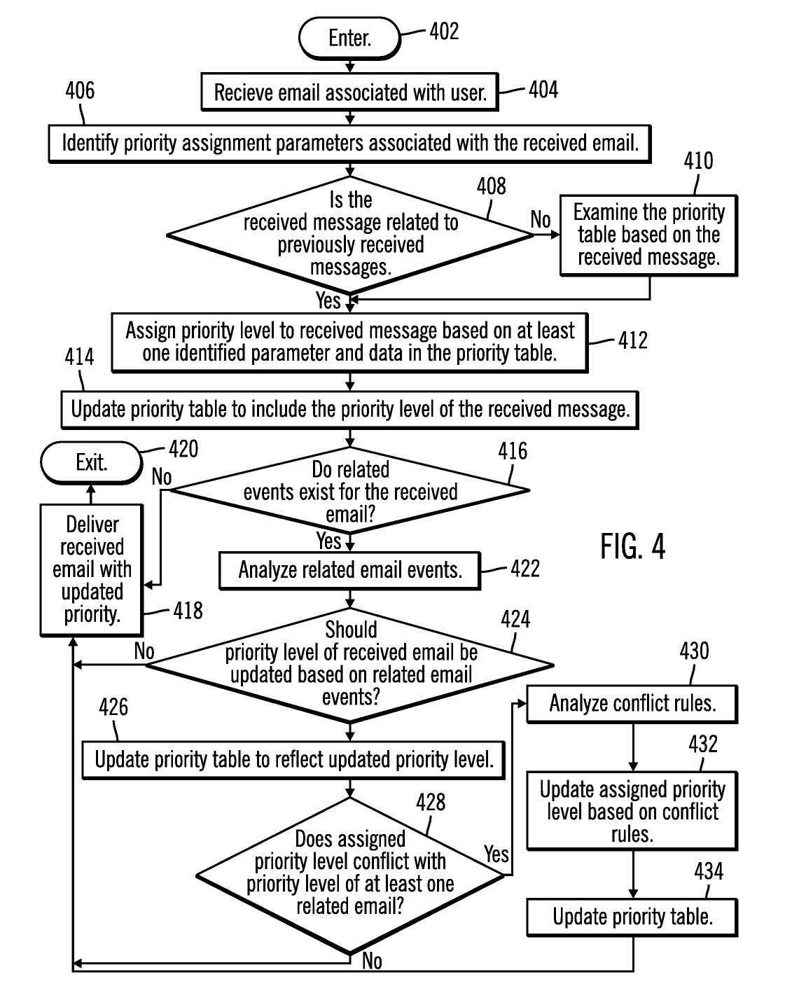

FIG. 4 is an operational diagram illustrating an exemplary process of assigning and adjusting priority levels associated with email messages according to an embodiment of the present invention. The operational flow diagram of FIG. 4 begins at step 402 and flows directly to step 404. An email 121 is received at step 404. The priority manager 112 identifies priority assignment parameters 124 associated with the received email 121 at step 406. For example, the priority manager 112 analyzes the email messages 121 to determine, based upon the contents of that messages, relationships of addresses, and relationships to other messages, the priority assignment parameters 124 that are to be used to determine a priority level for the message 121 are based on, for example, priority assignment rules 130.

The priority manager 112 determines if the received message is related to any previously received messages at step 408. If the result of this determination is positive, the control flows to step 412. If the result of this determination is negative, the priority manager 112 examines the priority table 122 based on this message at step 410. For example, the priority table is examined to identify a priority level to assign to this message according to the rules defined by the user and/or system administrator within the priority table 122). The control then flows to step 412 where the priority manager 112 assigns a priority level to the received email 121 based on at least one identified priority assignment parameter and data in the priority table 122. The priority manager 112 updates the priority table 122 to include the assigned priority level of the received message at step 414.

The priority manager 112 determines if any related email events exist that are associated with the received message at step 416. If the result of this determination is negative, the priority manager 112 delivers the received email 121 with the assigned priority level to the user at step 418. The control flow then exits at step 420. If the result of this determination is positive, the priority manager 112 analyzes the related email events at step 422. The priority manager 112 determines if the priority level of a related email or the currently received email be updated based on the related email events at step 424. If the result of this determination is negative, the control flows to step 418. If the result of this determination is positive, the priority manager 112 updates the priority table 122 to reflect the update priority level at step 426.

The priority manager 112 then determines if the assigned priority level conflict with a priority level assigned to at least one related email at step 428. If the result of this determination is negative, the control flows to step 418. If the result of this determination is positive, the priority manager 112 analyzes conflict rules 132 at step 430. The priority manager 112 updates the assigned priority level based on one or more conflict rules 132 at step 432. The priority manager 112 updates the priority table 122 to show the update priority level at step 434. The control then flows to step 418.

Another Process of Assigning and Adjusting Priority Levels for Email Messages

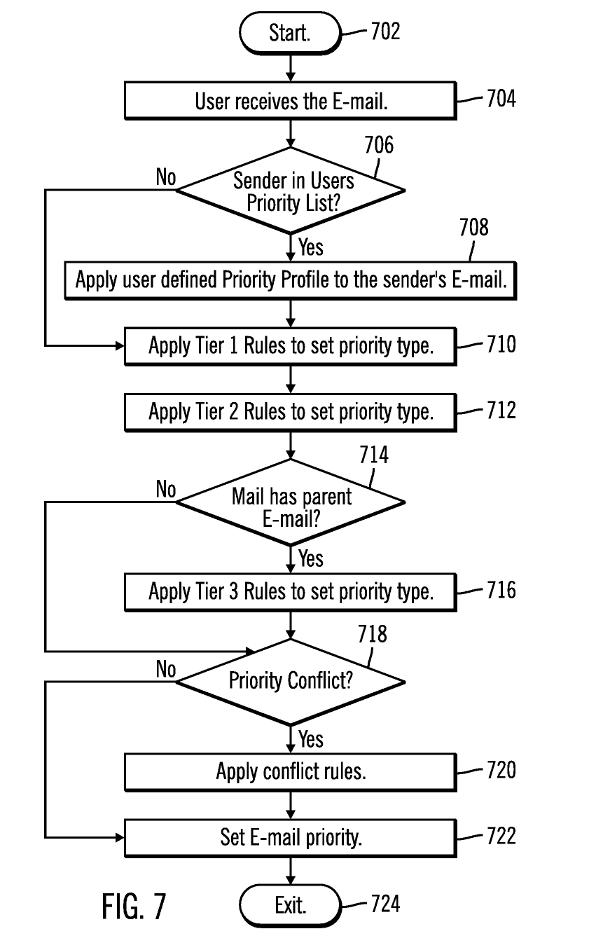

FIG. 7 is an operational diagram illustrating another exemplary process of assigning and adjusting priority levels associated with email messages according to an embodiment of the present invention. The operational flow diagram of FIG. 7 begins at step 702 and flows directly to step 704. A user receives an email message at step 704. The priority manager 112 determines, at step 706, if the sender is in the recipient user's priority list. The priority list can be defined for a certain category of people such as team members, customers, or the like. In one embodiment, a priority list is based on user defined types such as high, medium, and low.

If the result of this determination is negative the control flows to step 710. If the result of this determination is positive, the priority manager 112 applies a user defined priority profile/priority assignment definitions 124 to the received email message at step 708. The priority manager 112 applies a first set of priority rules at step 710 and a second set of priority rules at step 712 to assign a priority level to the received message. In one embodiment, the first set of priority rules can be based on an earlier defined priority of the email message, keywords such as “urgent”, “FYI”, and the like, and the location of the recipient's email address within the message such as in the addressee list, “CC” list, “BCC” list, or the like. The second set of priority rules, in one embodiment, can be based on a context defined by the user. For example, a message received from a member of a management group can be associated with a specific priority level. In another example, colleagues working on a project at a different location than the user can be associated with a different priority than group members at the same location as the user.

The priority manager 112 determines if the received message is associated with a parent message at step 714. For example, the priority manager 112 analyzes a priority table 122 that tracks a message's dependencies and roles of a sender. If the result of this determination is negative, the control flows to step 718. If the result of this determination is positive, the priority manager 112 applies a third set of priority rules to the received message at step 716. In one embodiment, the third set of rules can be based on the priority table 122. For example, if the recipient user is directly addressed and the email has been responded to by multiple people then the email can be associated with a higher priority level than if fewer peopled responded to the message.

The priority manager 112 determines if a priority conflict exists at step 718. If the result of this determination is negative the control flows to step 722. If the result of this determination is positive, the priority manager 112 applies a set of conflict rules 132 at step 720. One example of a conflict rules states that the highest priority is assigned to the received message. Another example is that the last priority assigned is used. Yet another example is that an average of priorities is used. For example, if the priority level of two conflicting rules are “high” and “medium” then the average would be “medium-high”. The priority manager 112 then assigns a priority message to the received message at step 722. The control flow exits at step 724.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for at least one of assigning and dynamically adjusting a priority level associated with an email message, the method comprising:
receiving at least one email message associated with a recipient;
accepting, from a user, definitions of a plurality of priority assignment parameters and respective priority levels that are associated with each of the plurality of priority assignment parameters;
identifying, within the at least one email message, at least one identified priority assignment parameter within the plurality of priority assignment parameters; and
assigning, to the at least one email message, a corresponding priority level that is associated with the at least one identified priority assignment parameter.

2. The method of claim 1, further comprising:
defining a plurality of priority assignment rules;
defining a priority assignment rule application sequence for applying the plurality of priority assignment rules to the at least one email message; and
adjusting the priority level associated with the at least one email message by applying the at least one priority assignment rule to the at least one email message according to the priority assignment rule application sequence.

3. The method of claim 1, further comprising:
determining that a priority level conflict exists between the at least one email message and at least one other email message; and
adjusting, in response to determining that a priority level conflict exists, the priority level that has been assigned to the at least one email message to resolve, based upon user defined priority conflict rules, the conflict.

4. The method of claim 1, wherein at least one priority assignment parameter within the plurality of priority assignment parameters is dependent upon externally stored data.

5. The method of claim 1, further comprising:
creating a priority table associated with the recipient, wherein the priority table comprises at least a respective unique identifier for each email message within the at least one email message received by the recipient, and the priority table further comprises a respective priority level indicator associated with the each email message; and
updating the priority table with priority levels assigned to the at least one email message.

6. The method of claim 1, wherein the plurality of priority assignment parameters is defined within a priority assignment rule that defines a set of priority assignment parameters to identify within the at least one email message.

7. The method of claim 1, wherein at least one of the plurality of priority assignment parameter comprises at least one of:
text within the at least one email message;
a location of the email address associated with the recipient within a list of addresses of the at least one email message;
a context relationship between a sender of the at least one email message and the recipient;
a context associated with the sender;
a total number of addressees associated with the at least one email message; and
a priority profile associated with the at least one email message, wherein the priority profile indicates a priority level that is to be assigned to a received email message based on the sender of the received email address.

8. The method of claim 1, further comprising:
determining a relationship between the at least one email message and at least one other email message, wherein the relationship is defined within the plurality of priority assignment parameters; and
adjusting the corresponding priority level of the at least one email message based at least in part on the relationship.

9. The method of claim 8, wherein the adjusting further comprises:
adjusting, in response to adjusting the priority level, a priority level associated with the at least one other email message based at least in part on at least one priority assignment parameter associated with the at least one email message.

10. An information processing system for at least one of assigning and dynamically adjusting a priority level associated with an email message, the information processing system comprising:
a processor;
a memory communicatively coupled to the processor;
an email client adapted to receive at least one email message associated with a recipient;
a priority manger adapted to accept definitions of a plurality of priority assignment parameters and respective priority levels that are associated with each of the plurality of priority assignment parameters and identify at least one priority assignment parameter within the at least one email message; and
a priority assigner adapted to assign a corresponding priority level that is associated with the at least one identified priority assignment parameter.

11. The information processing system of claim 10, further comprising a priority updater adapted to:
determine that a priority level conflict exists between the at least one email message and at least one other email message; and
adjust, in response to determining that a priority level conflict exists, the priority level that has been assigned to the at least one email message to resolve, based upon user defined priority conflict rules, the conflict.

12. The information processing system of claim 10, further comprising:
a priority table generator adapted create a priority table associated with the recipient, wherein the priority table comprises at least a respective unique identifier for each email message within the at least one email message received by the recipient, and the priority table further comprising a respective priority level indicator associated with the each email message; and
a priority table updater adapted to update the priority table with priority levels assigned to the at least one email message.

13. The information processing system of claim 10, wherein the priority manager is further adapted to:
determine a relationship between the at least one email message and at least one other email message, wherein the relationship is defined within the plurality of priority assignment parameters; and
wherein the information processing system further comprises:
a priority updater adapted to adjust the corresponding priority level of the at least one email message based at least in part on the relationship.

14. The information processing system of claim 13, wherein the priority updater is further adapted to:
adjust, in response to adjusting the priority level, a priority level associated with the at least one other email message based at least in part on at least one priority assignment parameter associated with the at least one email message.

15. A computer program product for at least one of assigning and dynamically adjusting a priority level associated with an email message, the computer program product comprising:
a storage medium readable by a processing circuit and storing instructions for execution by the processing circuit for performing a method comprising:
receiving at least one email message associated with a recipient;
accepting, from a user, definitions of a plurality of priority assignment parameters and respective priority levels that are associated with each of plurality of priority assignment parameters;
identifying, within the at least one email message, at least one identified priority assignment parameter within the plurality of priority assignment parameters; and
assigning, to the at least one email message, a corresponding priority level that is associated with the at least one identified priority assignment parameter.

16. The computer readable storage medium of claim 15, wherein the method further comprises:
determining that a priority level conflict exists between the at least one email message and at least one other email message; and
adjusting the priority level that has been assigned to the at least one email message to resolve, based upon user defined priority conflict rules, the conflict.

17. The computer readable storage medium of claim 15, wherein the method further comprises:
creating a priority table associated with the recipient, wherein the priority table comprises at least a respective unique identifier for each email message within the at least one email message received by the recipient, and the priority table further comprising a respective priority level indicator associated with the each email message; and
updating the priority table with priority levels assigned to the at least one email message.

18. The computer readable storage medium of claim 15, wherein the plurality of priority assignment parameter is defined within a priority assignment rule that defines a set of priority assignment parameters to identify within the at least one email message.

19. The computer readable storage medium of claim 15, wherein the method further comprises:
creating a priority table associated with the recipient, wherein the priority table comprises at least a respective unique identifier for each email message within the at least one email message received by the recipient, and the priority table further comprises a respective priority level indicator associated with the each email message; and
updating the priority table with the priority level assigned to the at least one email message.

20. The computer readable storage medium of claim 15, wherein the method further comprises:
determining a relationship between the at least one email message and at least one other email message, wherein the relationship is defined within the plurality of priority assignment parameters; and
adjusting, in response to determining that a priority level conflict exists, the corresponding priority level of the at least one email message based at least in part on the relationship; and
adjusting, in response to adjusting the priority level that has been assigned to the at least one email message, a priority level associated with the at least one other email message based at least in part on at least one priority assignment parameter associated with the at least one email message.
